(19) United States
(12) Patent Application Publication
(10) Pub. No.: US 2020/0255147 A1
(43) Pub. Date: Aug. 13, 2020

(54) SYSTEMS AND METHODS FOR AERIAL MATERIAL DISPERSION

(71) Applicant: Aerial Crane Enterprises LLC, Farmington, UT (US)

(72) Inventors: Travis Cooper Wayland, Farmington, UT (US); Jeffrey James Hill, San Angelo, TX (US)

(21) Appl. No.: 16/789,299

(22) Filed: Feb. 12, 2020

Related U.S. Application Data
(60) Provisional application No. 62/804,517, filed on Feb. 12, 2019.

(51) Int. Cl. B64D 1/18; B64C 27/04; A01M 21/04; A01M 9/00; B05B 12/00; B05B 12/02; B05B 12/16

(52) U.S. Cl. CPC B64D 1/18; B64C 27/04; A01M 21/043; B05B 12/16; B05B 12/006; B05B 12/02; A01M 9/0092

(57) ABSTRACT

Systems and methods for aerially dispersing one or more materials are disclosed herein. More particularly, but not exclusively, the subject application relates to systems and methods for maintaining a predetermined application rate of the material(s) to an area regardless of the speed of an aircraft over the area. As such, a constant application of the material(s) over the area may be achieved despite changes in speed of the aircraft relative to the area. In one form, for example, a system includes a container for holding the material(s) and a flow regulator positioned in communication with the container and structured to control release of the material(s) from the container. A controller is structured to control the flow regulator to adjust the rate at which the material is released from the container based on the speed of the container relative to an area to which the material is dispersed.

### CROSS-REFERENCE TO RELATED APPLICATIONS

The subject application claims priority to U.S. Provisional Patent Application No. 62/804,517 filed Feb. 12, 2019. The contents of this application are incorporated herein by reference in their entirety.

### BACKGROUND

The present application generally relates to aerially delivering or dispersing one or more materials to an underlying area. More particularly, but not exclusively, the present application relates to systems and methods for maintaining a predetermined application rate of the material(s) to an area regardless of the speed of an aircraft, from which the material(s) is/are delivered or dispersed, over the area. As such, a constant application rate of the material(s) over the area may be achieved despite changes in speed of the aircraft relative to the area. In some forms, the systems and methods disclosed herein may also maintain a predetermined application rate of the material(s) to the area while accounting for the elevation or altitude of the aircraft or an apparatus from which the material is released relative to the underlying area.

Different types of aircraft have been used to deliver various materials to areas underlying the flightpath of the aircraft. For example, helicopters and fixed wing aircraft may be used to deliver water or fire suppressant to fight wildfires. Fixed wing aircraft have also been used to treat crops with different materials such as herbicides and pesticides. Under these current approaches, achieving desired control of the distribution rate of the materials over the underlying areas has proved to be difficult. Amongst other things, current approaches may result in over-application of the materials to an underlying area which may cause, for example, excessive run-off of the materials to surrounding areas. In the context of the application of a herbicide for example, such run-off may have the unintended consequences of killing surrounding, non-targeted vegetation and/or affecting local water sources. Moreover, over-application of the materials results in product waste and, in turn, unnecessarily increases attendant costs. In contrast, current approaches may also result in under-application of the materials, which may result in a failure of the materials to provide the effect intended from their application. In many cases, such failure requires the expenditure of additional resources because a supplemental application of the materials may be required. Accordingly, there is a demand for further improvements in this area of technology.

The claimed subject matter is not limited to embodiments that solve any disadvantages or that operate only in environments such as those described above. Rather, this background is only provided to illustrate examples of where the present disclosure may be utilized.

### SUMMARY

Systems and methods for aerially delivering or dispersing one or more materials to an underlying area are provided. More particularly, but not exclusively, systems and methods for maintaining a predetermined application rate of the material(s) to the area regardless of the speed of an aircraft, from which the material(s) is/are delivered or dispersed, over the area. As such, a constant application rate of the material(s) over the area may be achieved despite changes in speed of the aircraft relative to the area. In some forms, systems and methods disclosed herein may also, or alternatively, compensate for altitude or elevation of the aircraft relative to the area in order to maintain a predetermined application of the material to the area.

In one embodiment, a system for aerial delivery of a material includes a container for holding the material having a lower opening, and a flow regulator positioned in communication with the lower opening of the container and structured to control release of the material from the container. The system also includes a spreader positioned in communication with the flow regulator and structured to radially disperse the material released from the container. A controller is in communication with the flow regulator and structured to control the flow regulator to adjust the rate at which the material is released from the container based on the speed of the container relative to an area to which the material is dispersed in order to maintain a predetermined application rate of the material to the area.

In another embodiment, a method includes coupling to an aircraft an apparatus that includes a container for holding a material having a lower opening, a flow regulator positioned in communication with the lower opening of the container and structured to control release of the material from the container, and a spreader positioned in communication with the flow regulator and structured to radially disperse the material released from the container. The method also includes operating the helicopter over an area, dispensing the material to the area, and automatically adjusting the rate at which the flow regulator releases the material from the container based on speed of the aircraft relative to the area.

Other aspects include unique methods, systems, devices, kits, assemblies, equipment, and/or apparatus related to aerial delivery of one or more materials to an area. Further aspects, embodiments, forms, features, benefits, objects, and advantages shall become apparent from the detailed description and figures provided herewith.

This Summary is provided to introduce a selection of concepts in a simplified form that are further described below in the Detailed Description. This Summary is not intended to identify key features or essential characteristics of the disclosed subject matter, nor is it intended to be used as an aid in determining the scope of the disclosed subject matter.

Additional features and advantages will be set forth in the description which follows, and in part will be obvious from the description, or may be learned by the practice of the invention. The features and advantages may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE FIGURES

FIG. 1 is a schematic illustration of a system for aerial delivery of one or more materials;

FIG. 2 is a flow chart illustrating an operation of the system illustrated in FIG. 1;

FIG. 3 is a flow chart illustrating another operation of the system illustrated in FIG. 1;

FIG. 4 is a schematic illustration of a use of the system of FIG. 1 relative to an area to which the one or more materials is delivered; and

FIG. 5 is a schematic illustration of an example computing device that is arranged to perform, where applicable, any of the methods described herein.

### DETAILED DESCRIPTION OF REPRESENTATIVE EMBODIMENTS

For purposes of promoting an understanding of the present disclosure, reference will now be made to the following embodiments and specific language will be used to describe the same. It will nevertheless be understood that no limitation of the scope of the disclosure is thereby intended, such alterations and further modifications in the described subject matter, and such further applications of the disclosed principles as described herein being contemplated as would normally occur to one skilled in the art to which the disclosure relates.

The terms and words used in the following description and claims are not limited to the bibliographical meanings, but, are merely used to enable a clear and consistent understanding of the disclosure. It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The present application generally relates to aerially delivering or dispersing one or more materials to an underlying area. More particularly, but not exclusively, the present application relates to systems and methods for maintaining a predetermined application rate of the material(s) to an area regardless of the speed of an aircraft, from which the material(s) is/are delivered or dispersed, over the area. As such, a constant application rate of the material(s) to the area may be achieved despite changes in speed of the aircraft relative to the area. In addition, in some forms, a constant application rate of the materials to the area may also be achieved while accounting for the relative elevation or altitude between the aircraft or a container from which the material is released and the area.

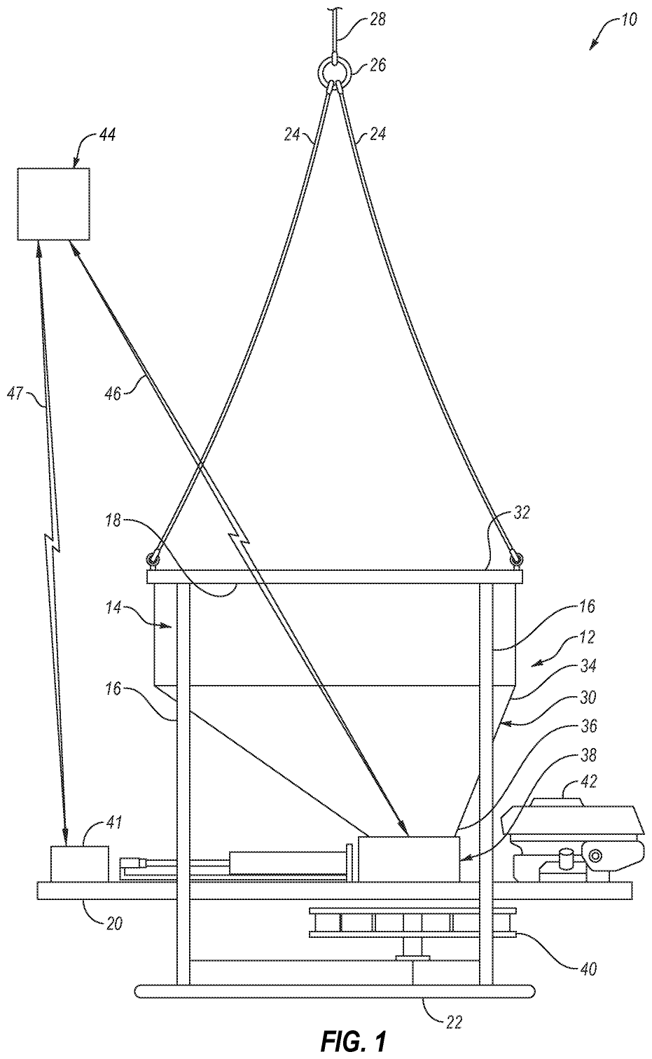

Turning now to FIG. 1, there is schematically illustrated a system 10 structured to aerially deliver one or more materials, hereinafter referred to as the material. System 10 includes an apparatus 12 which may carry the material and release the material therefrom for application to an area. More specifically, apparatus 12 includes a frame 14 which provides support for various components of apparatus 12. Frame 14 includes a number of vertical members 16 coupled to an upper member 18, an intermediate member 20, and a lower member 22. A number of cables or similar components 24 may be coupled to frame 12 and meet at connection 26 from which another cable or similar component 28 extends for coupling to an aircraft such as, for example, a helicopter. Amongst other things, lower member 22 provides a support platform for apparatus 12 on an underlying surface when it is placed on the ground for example.

Apparatus 12 also includes a container 30 structured to store or hold the material until release. In one form, container 30 may include an upper end 32 which has one or more openings through which the material may be placed into container 30. These openings may include one or more covers in order to close or seal upper end 32 of container 30. It should be appreciated that other configurations for container 30 are contemplated. For example, in one non-illustrated form, upper end 32 may be closed and container 30 may include one or more openings along its sidewall 34 through which the material may be placed into container 30. In this form, one or more covers may be provided in order to close or seal these openings and retain the materials in container 30 and protect the material from contamination from external sources.

In the illustrated form, container 30 generally has a conical shape that is truncated at lower end 36 and also has an opening at lower end 36 through which the material may exit. For example, when used in the position illustrated, gravity forces the material toward lower end 36 of container 30. It should be appreciated that container 30 may also include one or more baffles, augers, agitators or similar components to guide the material to lower end 36 and/or keep the material from bridging in container 30. It should be appreciated that container 30 may be shaped other than conically in other non-illustrated forms, and may be provided with any shape suitable for holding the material.

A flow regulator or controller 38 is positioned below container 30 and in communication with the opening on lower end 36 of container 30. Generally speaking, flow regulator 38 is structured to control the rate at which the material is released from container 30. As such, flow regulator 38 may function to entirely prevent release of the material from container 30, and to facilitate selective release of the material from the container 30. In one form, flow regulator 38 may have variable speed functionality such that material may be released from container 30 across a range of rates extending from non-release of the material to a maximum release rate of the material. In other forms for example, flow regulator 38 may have one or more predefined speeds at which it operates to release material from container 30. It is contemplated that flow regulator 38 may have any number of structures suitable for controlling release of material from container 30. In one form for example, flow regulator 38 includes an impeller or similar component which, upon rotation, facilitates release of material from container 30. In this form for example, when the impeller is not rotating, material is not released from container 30. However, as the impeller rotates, material will be released from container 30, and as the speed of rotation increases, the rate at which the material is released from container 30 also increases. In an alternative form for example, flow regulator 38 may include an auger which, when not rotating, prevents release of material from container 30. However, as the auger rotates, material will be released from container 30, and as the rotation speed of the auger increases, the rate at which the material is released also increases.

Apparatus 12 also includes a spreader 40 positioned below flow regulator 38. Spreader 40 is positioned in communication with flow regulator 38 such that material released from container 30 by flow regulator 38 is directed to spreader 40. More specifically, but not exclusively, in one form the material from flow regulator 38 may be delivered to or near the center of spreader 40. Spreader 40 is rotatable about a central axis, and upon its rotation material delivered to it by flow regulator 38 is centrifugally forced in an outward direction to be broadcast spread over an area under the spreader. In one form, spreader 40 may include one or more vanes or ridges which direct the material released from container 30 as it is centrifugally forced outwardly. During operation of apparatus 12, spreader 40 may be continually operated regardless of the operation status of flow regulator 38, or it may only operate when flow regulator 38 operates. In addition, in one form, spreader 40 may operate at a single, steady rate regardless of the rate at which material is released from container 30 by flow regulator 38. However, in other forms, the speed at which spreader 40 operates may be a function of the rate at which flow regulator 38 releases material from container 30, and the speed of spreader 40 may be automatically adjusted based on the rate at which material is released from container 30. However, it is also contemplated that the speed at which spreader 40 rotates may be remotely adjusted by an operator of the aircraft to which apparatus 12 is coupled.

Apparatus 12 also includes an altimeter 41 or a similar device which is structured to determine the elevation or altitude of apparatus 12 relative to the area to which the material is delivered. Altimeter 41 may be, for example, a radar altimeter or a laser altimeter utilizing one or more laser distance sensors. In some forms, an altimeter 41 may be positioned on the aircraft in addition to or in lieu of its placement on apparatus 12.

In the illustrated form, apparatus 12 also includes a power source 42 mounted to intermediate member 20. Power source 42 may provide power to flow regulator 38, spreader 40, or both flow regulator 38 and spreader 40. In one form, power source 42 may be a battery or electrical generator which provides an electrical current to power flow regulator 38 and/or spreader 40. In another form, power source 42 may be an internal combustion engine which provides power to rotate spreader 40 through, for example, a mechanical connection such as a belt or shaft. In this and other forms, flow regulator 38 may receive power from an alternative source including for example the aircraft to which apparatus 12 is coupled.

System 10 also includes a controller 44 which is in communication with flow regulator 38 via a communication link 46 and with altimeter 41 via a communication link 47. Communication link 46 may be provided wirelessly and utilize, for example, a Bluetooth or Wi-Fi connection, or it could be provided by a hardwired connection between controller 44 and flow regulator 38. Similarly, communication link 47 may be provided wirelessly and utilize, for example, a Bluetooth or Wi-Fi connection, or it could be provided by a hardwired connection between controller 44 and altimeter 41. In other non-illustrated forms, it is contemplated that flow regulator 38 and altimeter 41 may utilize a common communication link with controller 44.

Generally speaking, controller 44 is structured to control flow regulator 38, and in turn the rate at which material is released from container 30, in order to achieve a predetermined application or distribution rate to an area to which the material is/will be applied regardless of the speed of the aircraft relative to the area. For example, when the material is a granular herbicide, an application rate in terms of weight per acre may be determined based on a number of factors including, for example, the concentration of the active ingredient and the desired end result. In some instances, the application rate may be prescribed by the manufacturer of the material and/or regulated by one or more relevant agencies. It should be appreciated that once the application rate is established, and the distribution area of the material delivered from apparatus 12 is known, then the rate at which the material must be released from container 30 at a given speed of the aircraft over the area in order to achieve the desired application rate may be determined. However, if the aircraft deviates from that speed, it may result in failure to achieve the application rate due to over-application or under-application.

Controller 44 however may include, for example, a GPS-based navigation system from which speed of the aircraft and, in turn, apparatus 12 may be determined. Alternatively, system 10 could include one or more sensors in communication with controller 44 which provide measurements from which the ground speed of the aircraft, and in turn, apparatus 12 may be determined. Based on a known speed of the aircraft relative to the area to which the material is/will be applied, the rate at which the material should be released from container 30 in order to maintain the desired application rate may be determined from a relevant look-up table established from the information discussed in the foregoing paragraph. Alternatively, controller 44 may also be structured to execute one or more relevant algorithms in order to determine the rate at which the material should be released from container 30 in order to maintain the desired application rate at any given speed of the aircraft relative to the area to which the material is applied. As such, controller 44 is structured to automatically and continuously determine the speed of the aircraft and control, through flow regulator 38, the rate at which the material is released from container 38 in order to maintain a consistent application rate. Similarly, and generally speaking, controller 44 is structured to increase the release rate of the material as the speed of the aircraft relative to the area increases, and to decrease the release rate of the material as the speed of the aircraft relative to the area decreases, all while maintaining a desired application rate of the material. While not previously discussed, it should be appreciated that the automatic adjustment of the flow rate of material from container 30 provided by controller 44 maintains a consistent application rate of the material to the area without the need for the operator of the aircraft to continually monitor speed and release rate. Similarly, beyond programming controller 44 with a relevant application rate in connection with a given area and material, further operator input is unnecessary and attention may be directed to operation of the aircraft. While not previously mentioned, it should be appreciated that controller 44 may be, for example, a variant of an AG-NAV (Ontario, Canada) navigation and/or application control system.

Controller 44 may additionally or alternatively be structured to control flow regulator 38, and in turn the rate at which material is released from container 30, in order to achieve a predetermined application or distribution rate to an area to which the material is/will be applied while accounting for the altitude or elevation of apparatus 12, or the related aircraft, relative to the area. For example, if apparatus 12 is below a certain altitude relative to the underlying area, then material which is radially broadcast or otherwise dispersed from container 30 may not reach its full broadcast area before it falls to the surface of the underlying area. Similarly, the material released from apparatus 12 will cover a smaller area, and this may result in over-application of the material to that area. With a known altitude of apparatus 12 at which this type of over-application may occur, controller 44 may slow the rate at which material is released from container 30 when apparatus 12 is below this altitude in order to avoid over-application of the material and otherwise maintain, or substantially maintain, a desired application rate of the material to the area. Similarly, in operation, altimeter 41 may provide the altitude of apparatus 12 to controller 44 and controller 44 may, if the altitude of apparatus 12 is below a predefined value, slow through flow regulator 38 the rate at which material is released from container 30 in order to maintain, or substantially maintain, a desired application rate of the material to the area. In other forms where altimeter 41 is positioned on the aircraft, the elevation or altitude of the aircraft provided by altimeter 41 may be adjusted by controller 44 to account for the distance below the aircraft by which apparatus 12 is positioned.

In forms where controller 44 may control flow regulator 38, and in turn the rate at which material is released from container 30, while accounting for the altitude or elevation of apparatus 12 relative to the underlying area, controller 44 may for example first determine the rate at which the material should be released from container 30 based on the known speed of the aircraft relative to the area. After the release rate is determined, controller 44 may determine if the altitude of apparatus 12 is below a predefined value and, if so, may further determine if the determined release rate based on speed of the aircraft should be adjusted. For example, controller 44 may determine that the determined release rate based on speed of the aircraft should be lowered, and lower the release rate through flow regulator 38, because the altitude of apparatus 12 is below the predefined value. However, if the determined release rate based on speed of the aircraft already corresponds to or is lower than a release rate prescribed for situations where the altitude of apparatus 12 is below the predefined value, then controller 44 will not adjust the release rate which was previously determined based on speed of the aircraft. After the altitude of apparatus 12 is above the predefined value, controller 44 will again determine the release rate of the material from container 30 based on the speed of the aircraft relative to the underlying area.

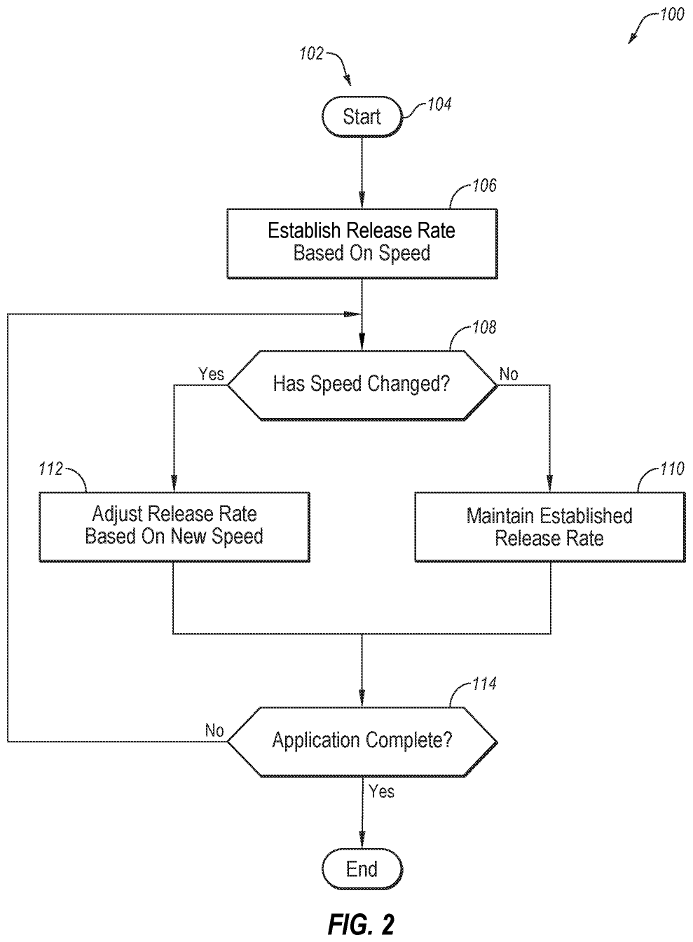

As indicated above, in one form system 10 may be used for aerially dispensing or distributing a material to an area, such as a ground surface, which lies below the aircraft utilized in connection with system 10. In one non-limiting form for example, the aircraft may be a helicopter, the area includes vegetation, and the material is a herbicide selected to eradicate all or part of the vegetation in the area. In one form, the herbicide is provided in a granular form. Further details regarding one technique 100 for using system 10 in this manner will now be provided in connection with the schematic flow diagram illustrated in FIG. 2.

Technique 100 includes an operation 102 which regulates the rate at which material is released from container 30 by flow regulator 38 in order to maintain a target application rate of the material regardless of aircraft speed relative to the underlying area. The determination of the rate at which the material is released may be based on events recorded and analyzed by controller 44, such as receiving a manual input of the target application rate and receiving various signals indicative of speed of the aircraft relative to the underlying area. At step 104, operation 102 begins and proceeds to step 106 where the rate at which the material is released is established or determined based on the speed of the aircraft relative to the underlying area in order to achieve the target application rate of the material to the area. Following step 106, operation 102 continuously monitors the speed of the aircraft relative to the underlying area as indicated by conditional 108 and assesses if the speed of the aircraft has changed. If the speed has not changed, operation 102 moves to step 110 where the flow rate initially established in step 106 is maintained. However, if it is determined at step 108 that speed has changed, then the rate at which material is released from container 30 is adjusted based on the new speed in order to substantially or completely maintain the desired application rate. Regardless of the outcome at conditional 108, operation 102 continues to conditional 114 where it is assessed if application of the material has been completed. If the application has been completed, then operation 102 ends. However, if the application has not been completed, then operation 102 returns to step 108 and continues on as previously described until the application is complete.

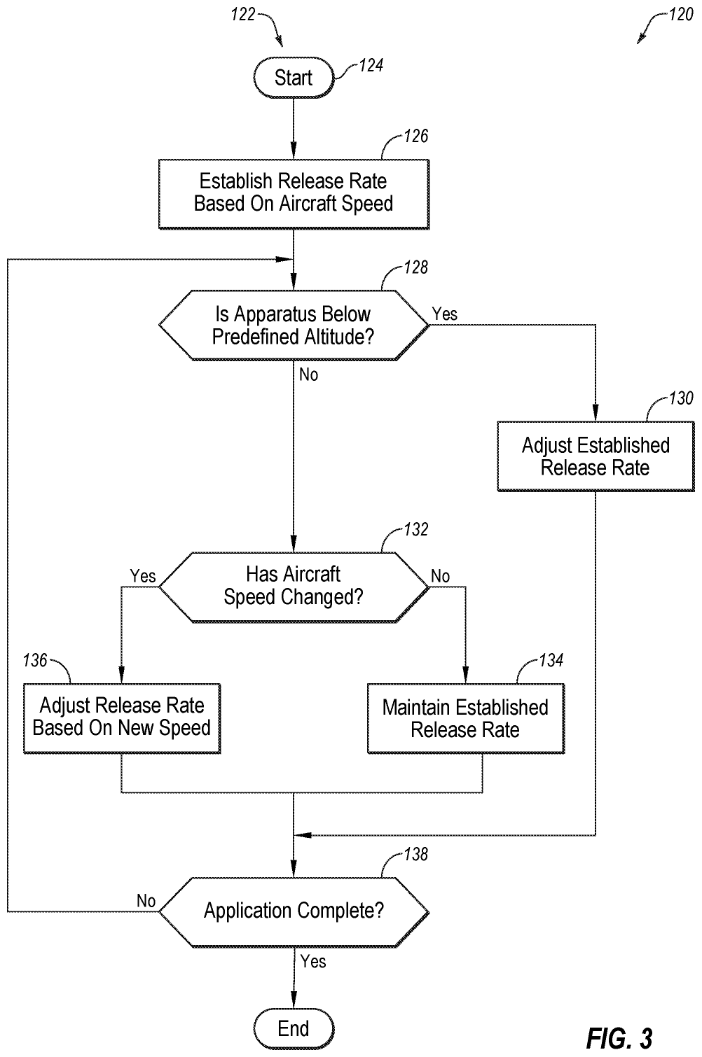

Further details regarding another technique 120 for using system 10 are provided in connection with the schematic flow diagram illustrated in FIG. 3. Technique 120 includes an operation 122 which regulates the rate at which material is released from container 30 by flow regulator 38 in order to maintain a target application rate of the material regardless of aircraft speed relative to the underlying area and while also taking into account instances where apparatus 12 is below a predefined altitude relative to the underlying area. The determination of the rate at which the material is released may be based on events recorded and analyzed by controller 44, such as receiving a manual input of the target application rate and receiving various signals indicative of speed of the aircraft relative to the underlying area and the altitude of the aircraft and/or apparatus 12. At step 124, operation 122 begins and proceeds to step 126 where the rate at which the material is released is established or determined based on the speed of the aircraft relative to the underlying area in order to achieve the target application rate of the material to the area. Following step 126, operation 122 monitors the altitude of apparatus 12 relative to the underlying area as indicated by conditional 128 and assesses if apparatus 12 is below a predefined altitude. If apparatus 12 is below the predefined altitude, operation 122 moves to conditional 130 where controller 44 determines if the release rate established in step 126 should be adjusted, and adjusts the release rate as appropriate, in light of the altitude of apparatus 12.

If apparatus 12 is not below the predefined altitude, operation 122 continues to monitor the speed of the aircraft relative to the underlying area as indicated by conditional 132 and assesses if the speed of the aircraft has changed. If the speed has not changed, operation 122 moves to step 134 where the flow rate initially established in step 126 is maintained. However, if it is determined at step 132 that speed has changed, then the rate at which material is released from container 30 is adjusted at step 136 based on the new speed in order to substantially or completely maintain the desired application rate. Regardless of the outcome at conditional 132, operation 122 continues to conditional 138 where it is assessed if application of the material has been completed. If the application has been completed, then operation 122 ends. However, if the application has not been completed, then operation 122 returns between step 126 and conditional 128 and continues on as previously described until the application is complete.

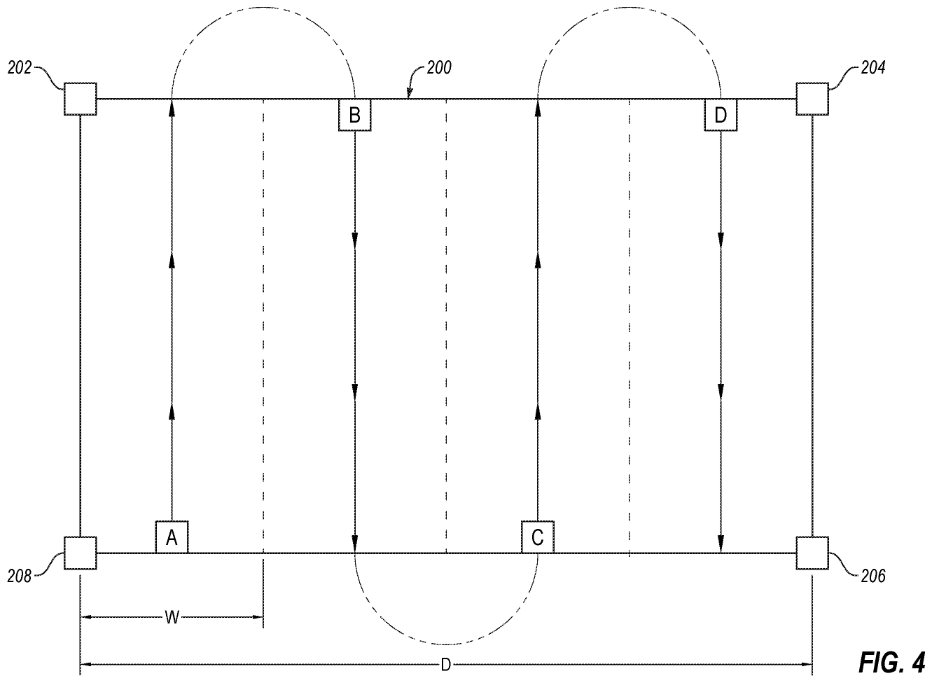

As indicated above, controller 44 may include a GPS-based navigation system. With further reference to FIG. 4 for example, further details will be provided with respect to the operation of system 10 relative to parcel 200 to which material in container 30 will be applied when controller 44 includes a GPS-based navigation system. More specifically, geographical coordinates for parcel 200 corresponding to corners 202, 204, 206, and 208 may be entered into controller 44. Controller 44 may also be programmed with the width W at which the material is distributed by spreader 40, and the distance Di between opposite ends or sides of parcel 200 may be divided by width W in order to determine the location and number of passes necessary across parcel 200 to adequately apply the material to parcel 200 while also trying to avoid duplicative application of the material to any particular portion(s) of parcel 200. In the illustrated form, controller 44 determines that four flightpaths, A, B, C and D, should be utilized for application of the material to parcel 200. The location of each of flightpaths A, B, C and D may be provided to an operator of the aircraft on a visual display such as a screen for example, and the operator may fly the aircraft along each of the displayed flightpaths. For example, the aircraft may first proceed down and complete flightpath A, fly outside of parcel 200 to flightpath B, proceed down and complete flightpath B, fly outside of parcel 200 to flightpath C, proceed down and complete flightpath C, fly outside of parcel 200 to path D, and proceed down and complete flightpath D in order to suitably apply the material to parcel 200. Since the boundaries of parcel 200 are programmed into controller 44, controller 44 may automatically start and stop delivery of material from container 30 in order to avoid release, either substantially or entirely, of the material to areas outside of parcel 200. For example, as the aircraft approaches and flies along path A, controller 44 may initiate release of material from container 30 and its distribution to parcel 200 once the aircraft is suitably positioned over parcel 200 in order to avoid, either substantially or entirely, release of the material outside of parcel 200 before the aircraft proceeds along flightpath A. Similarly, once the aircraft nears the opposite boundary of parcel 200 along flightpath A, controller 44 may terminate release of the material from container 30 and its distribution to parcel 200 in order to avoid, either substantially or entirely, release of the material outside of parcel 200 after the aircraft has completed its flight along flightpath A. Controller 44 may similarly control release of material from container 30 as the aircraft proceeds along flightpaths B-D. It should be appreciated that controller 44 will adjust the release rate of material from container 30 in order to maintain the desired application rate, as discussed above, as the aircraft flies along each of flightpaths A-D.

While not previously discussed, it should be appreciated that controller 44 may be part of a processing subsystem that may be structured with controllers, modules, sensors, actuators, communication links, and other devices known in the art for performing the operations described herein. Controller 44 may be a single device or a distributed device, and the functions of controller 44 may be performed by hardware or software. All commands and information may be provided in alternate forms, some information may not be present in certain embodiments, and additional information may be present in certain embodiments. Information may be interpreted from sensor inputs, from datalink communications, from parameters on a storage medium readable by a computer, or through other information gathering devices understood in the art.

In certain embodiments, controller 44 includes one or more modules structured to functionally execute its operations, which underscores the structural independence of the aspects of controller 44 and illustrates one grouping of operations and responsibilities of controller 44. Other groupings that execute similar overall operations are understood within the scope of the present application. Modules may be implemented in hardware and/or software on computer readable medium, and modules may be distributed across various hardware or software components.

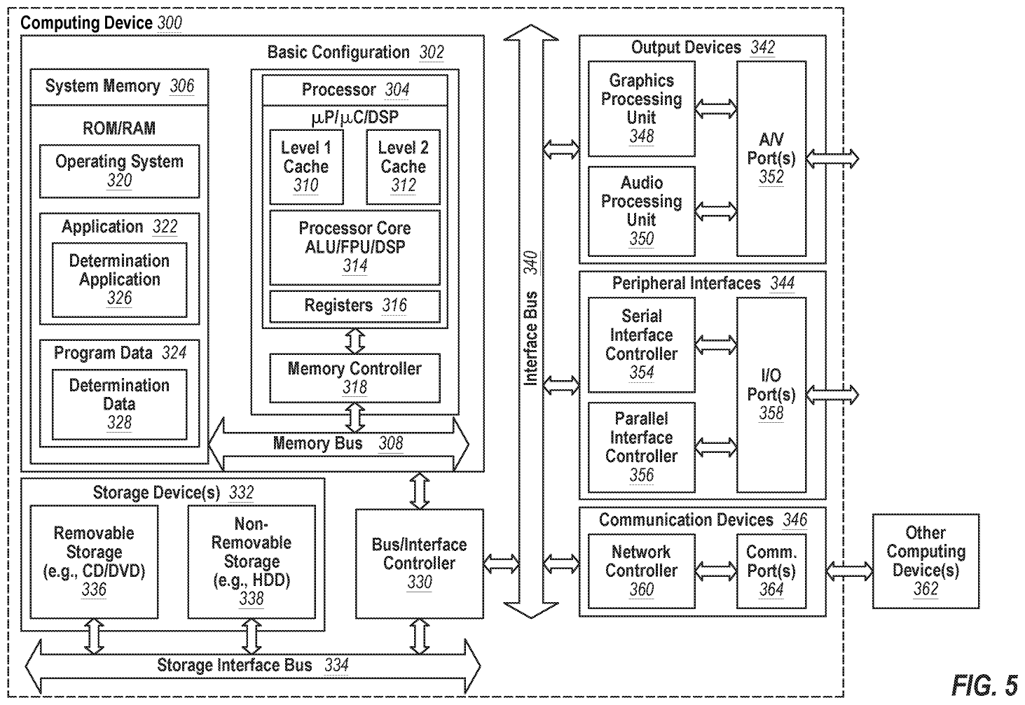

FIG. 5 shows an example computing device 300 that is arranged to perform, where applicable, any of the methods described herein. In a very basic configuration 302, computing device 300 generally includes one or more processors 304 and a system memory 306. A memory bus 308 may be used for communicating between processor 304 and system memory 306.

Depending on the desired configuration, processor 304 may be of any type including but not limited to a microprocessor (μP), a microcontroller (μC), a digital signal processor (DSP), or any combination thereof. Processor 304 may include one more levels of caching, such as a level one cache 310 and a level two cache 312, a processor core 314, and registers 316. An example processor core 314 may include an arithmetic logic unit (ALU), a floating point unit (FPU), a digital signal processing core (DSP Core), or any combination thereof. An example memory controller 318 may also be used with processor 304, or in some implementations memory controller 318 may be an internal part of processor 304.

Depending on the desired configuration, system memory 306 may be of any type including, but not limited to, volatile memory (such as RAM), non-volatile memory (such as ROM, flash memory, etc.) or any combination thereof. System memory 306 may include an operating system 320, one or more applications 322, and program data 324. Application 322 may include a determination application 326 that is arranged to perform the functions as described herein including those described with respect to methods described herein. Program Data 324 may include determination information 328 that may be useful for analyzing the contamination characteristics provided by the sensor unit 340. In some embodiments, application 322 may be arranged to operate with program data 324 on operating system 320 such that the work performed by untrusted computing nodes can be verified as described herein. This described basic configuration 302 is illustrated in FIG. 5 by those components within the inner dashed line.

Computing device 300 may have additional features or functionality, and additional interfaces to facilitate communications between basic configuration 302 and any required devices and interfaces. For example, a bus/interface controller 330 may be used to facilitate communications between basic configuration 302 and one or more data storage devices 332 via a storage interface bus 334. Data storage devices 332 may be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 306, removable storage devices 336 and non-removable storage devices 338 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 300. Any such computer storage media may be part of computing device 300.

Computing device 300 may also include an interface bus 340 for facilitating communication from various interface devices (e.g., output devices 342, peripheral interfaces 344, and communication devices 346) to basic configuration 302 via bus/interface controller 330. Example output devices 342 include a graphics processing unit 348 and an audio processing unit 350, which may be configured to communicate to various external devices such as a display or speakers via one or more AN ports 352. Example peripheral interfaces 344 include a serial interface controller 354 or a parallel interface controller 356, which may be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which may be arranged to facilitate communications with one or more other computing devices 362 over a network communication link via one or more communication ports 364.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 300 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 300 may also be implemented as a personal computer including both laptop computer and non-laptop computer configurations. The computing device 300 can also be any type of network computing device. The computing device 300 can also be an automated system as described herein.

The embodiments described herein may include the use of a special purpose or general-purpose computer including various computer hardware or software modules.

Embodiments within the scope of the present application also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to, physically mateable and/or physically interacting components and/or wirelessly interactable and/or wirelessly interacting components and/or logically interacting and/or logically interactable components.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one skilled in the art in light of this disclosure.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In one embodiment, any of the operations, processes, methods, or steps described herein can be implemented as computer-readable instructions stored on a computer-readable medium. The computer-readable instructions can be executed by a processor of a wide range of computing systems from desktop computing systems, portable computing systems, tablet computing systems, hand-held computing systems as well as network elements, and/or any other computing device. The computer readable medium is not transitory. The computer readable medium is a physical medium having the computer-readable instructions stored therein so as to be physically readable from the physical medium by the computer.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one skilled in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive, a CD, a DVD, a digital tape, a computer memory, any other physical medium that is not transitory or a transmission. Examples of physical media having computer-readable instructions omit transitory or transmission type media such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

While the invention has been illustrated and described in detail in the drawings and foregoing description, the same is to be considered as illustrative and not restrictive in character, it being understood that only certain embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A system for aerial delivery of a material, comprising:
a container for holding the material including a lower opening;
a flow regulator positioned in communication with the lower opening of the container and structured to control release of the material from the container;
a spreader positioned in communication with the flow regulator and structured to radially disperse the material released from the container; and
a controller in communication with the flow regulator and structured to control the flow regulator to adjust the rate at which the material is released from the container based on the speed of the container relative to an area to which the material is dispersed in order to maintain a predetermined application rate of the material to the area.

2. The system of claim 1, wherein the controller includes a GPS-based navigation unit.

3. The system of claim 2, wherein the speed of the container is determined by the GPS-based navigation unit.

4. The system of claim 1, wherein the controller is further structured to control the flow regulator to automatically adjust the rate at which the material is released from the container as speed of the container changes in order to maintain the predetermined application rate of the material to the area.

5. The system of claim 1, wherein the flow regulator includes an impeller or an auger structured to move the material from the container to the spreader.

6. The system of claim 1, further comprising a power source coupled to the spreader.

7. The system of claim 1, further comprising an adjustable valve positioned between the container and the flow regulator.

8. The system of claim 1, further comprising a communication link between the controller and the flow regulator.

9. The system of claim 8, wherein the communication link is wireless.

10. The system of claim 8, wherein the communication link is hardwired.

11. The system of claim 1, further comprising an altimeter in communication with the controller.

12. The system of claim 11, wherein the controller is further structured to adjust the rate at which the material is released from the container if an altitude value provided by the altimeter is below a predefined value.

13. A method, comprising:
coupling an apparatus to an aircraft, the apparatus including:
a container for holding a material including a lower opening;
a flow regulator positioned in communication with the lower opening of the container and structured to control release of the material from the container; and
a spreader positioned in communication with the flow regulator and structured to radially disperse the material released from the container;
operating the aircraft over an area;
delivering the material to the area; and
adjusting with a controller coupled to the flow regulator the rate at which the flow regulator releases the material from the container based on speed of the aircraft relative to the area.

14. The method of claim 13, wherein adjusting the rate at which the flow regulator releases the material from the container maintains a predetermined application rate of the material to the area regardless of the speed of the aircraft relative to the area.

15. The method of claim 13, wherein the area is an agricultural field or grazing pasture.

16. The method of claim 13, wherein the material is a herbicide.

17. The method of claim 13, wherein the aircraft is a helicopter.

18. The method of claim 13, further comprising:
operating the aircraft over the area at a first speed;
sensing deviation of speed of the aircraft from the first speed; and
in response to said sensing, automatically adjusting the rate at which the flow regulator releases the material from the container.

19. The method of claim 18, wherein in response to sensing an increase of speed over the first speed, automatically increasing the rate at which the flow regulator releases the material from the container.

20. The method of claim 18, wherein in response to sensing a decrease of speed over the first speed, automatically decreasing the rate at which the flow regulator releases the material from the container.

21. The method of claim 18, which further includes maintaining a predetermined application rate of the material to the area regardless of the speed of the aircraft relative to the area.

22. The method of claim 13, further comprising:
providing an altitude of the apparatus relative to the area; and
adjusting with the controller the rate at which the flow regulator releases the material from the container if the altitude of the apparatus is below a predefined value.

23. The method of claim 22, wherein the controller decreases the rate at which the flow regulator releases the material from the container if the altitude of the apparatus is below the predefined value.
